(19) United States
(12) Patent Application Publication
(10) Pub. No.: US 2009/0320112 A1
(43) Pub. Date: Dec. 24, 2009

(54) Method of Gaining Access to a Device

(76) Inventors: Niklas Magnusson, Taby (SE); Goran Brandt, Upplands Vasby (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/066,842

(22) PCT Filed: Sep. 28, 2006
(86) PCT No.: PCT/US06/37706

§ 371 Date: Mar. 14, 2008

Related U.S. Application Data
(60) Provisional application No. 60/723,520, filed on Oct. 4, 2005.

(51) Int. Cl. H04L 9/32; G06F 21/00; G06Q 30/00

(52) U.S. Cl. 726/7; 705/34

(57) ABSTRACT

The method is for activating a device. A communication device (14) is provided that is in communication with a server unit (20) that has a processor for generating a number series (38). An application device (16) has a processor (19) for generating a number series (36). The communication device (14) is not communicating directly with the application device (16). The user reads an identification number (30) and sends a message (32) including the identification number (30) to the server (20). The server (20) identifies a code number (42c) pointed at by a pointer (44) and sends back the code number (42c). The user enters the code number (42c) into the application device (16). The processor (19) compares the code number (42c) with a number (40c) pointed at by a pointer (37) and sends an activation signal to an activation device (18) to activate the application device.

### TECHNICAL FIELD

The present invention relates to a method of gaining access to a device such as unlocking a bathroom door or buying goods disposed inside a locked vending machine by activating the vending machine to dispense goods disposed therein.

### BACKGROUND OF INVENTION

Publicly available services such as public bathrooms and vending machines often require the user to pay to gain access such as unlocking the bathroom door or dispensing a food item inside the locked vending machine. Users many times do not have the correct or enough change to gain such access. This can be very inconvenient especially for distressed users. There is a need for a more effective way for the users to gain access to such services and places.

### SUMMARY OF INVENTION

The method of the present invention provides a solution to the above-outlined problems. More particularly, the method is for activating a device. A communication device is provided that is in communication with a server unit that has a processor for generating a number series. An application device has a processor for generating a number series. The communication device is not communicating directly with the application device. The user reads an identification number and sends a message including the identification number to the server. The server identifies a code number pointed at by a pointer and sends back the code number. The user enters the code number into the application device. For example, a keyboard may be used to enter the code number. The processor compares the code number with a number pointed at by a pointer and sends an activation signal to an activation device to activate the application device.

### BRIEF DESCRIPTION OF DRAWING

FIG. 1 is a schematic view of the components of the system of the present invention;

FIG. 2 is a schematic view showing number series for decoding a locking device of the system of the present invention; and

FIG. 3 is a schematic view of a subscription procedure to activate the system of the present invention.

### DETAILED DESCRIPTION

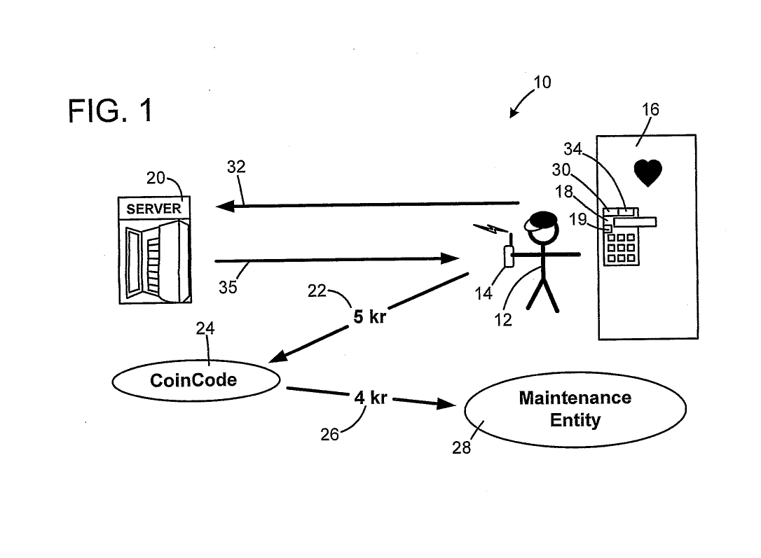

With reference to FIG. 1, the system 10 has a user 12 with a communication device 14 such as a mobile telephone. The user may desire to gain access to a service or device 16 such as unlocking a locked bathroom door that has a lock 18 with a microprocessor 19 and an identification number 55. It should be noted that the lock 18 is only used for illustrative purposes and that the method of the present invention may be used for a variety of applications such as activating and de-activating a vending machine, an electrical device, a shower, gambling device or any other suitable application.

The communication device 14 is in communication with a server 20 and the user is preferably charged a fee 22 by a service operator 24 that in turn may send a compensation fee 26 to, for example, a subscriber and/or maintenance entity 28 or any other type of owner or user. The maintenance entity 28 may maintain the device 16. It may also be possible to make the compensation fee 26 identical with the fee 22 and that the service operator 24 charges a leasing fee for the lock 18 to the maintenance entity 28. Preferably, every lock has a unique identification code.

More particularly, the user may start by reading an identification number or code 30 on the lock 18 and then, for example, send an SMS message 32 or any other suitable message to a number 34 displayed on the lock 18 or device 16. The server 20 receives the message 32 including the code 30 and returns an unlocking code 35 for the lock 18. The user enters the code 35 into the lock 18 that unlocks the door or device 16 so that the user 12 may gain access thereto.

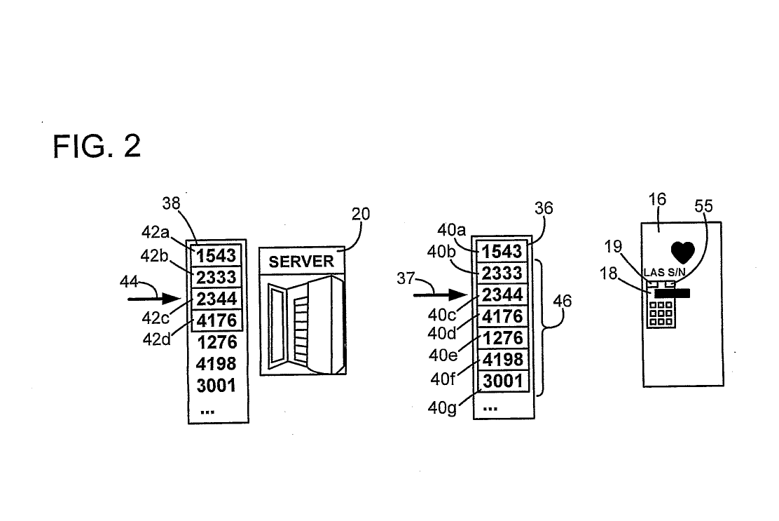

One important feature of the present invention is that the required unlocking code 35 changes with each user so that the users cannot use the same code to unlock the lock each time. As best shown in FIG. 2, the system 10 may have a first endless number series 36 at the microprocessor 19 that has a pointer 37 and a second endless number series 38 at the server 20 that has a pointer 44. One feature is that the various codes 40a, 40b, 40c, 40d of the series 36 preferably match codes 42a, 42b, 42c, 42d, respectively. In this way, the series 36 is preferably identical to the series 38. The pointers 37, 44 point to the code that is currently being used. Preferably, the pointers should point to the same codes so that pointer 37 points to code 40b when the pointer 44 points code 42b which is identical to code 40b. After each use the pointers move one step forward such as from code 40b to 40c and from code 42b to 42c at the same time.

The user 12 does not know which code opens the lock 18 at a particular time so that the user needs the code from the server 20. The pointer 37 may be set to point to the code, such as code 40c, that currently opens the lock. The server sends code 42c which is identical to the code 40c and the user can enter the code 42c to open the lock 18.

There may be situations when the pointer 44 is not synchronized with the pointer 37. For example, the user 12 may receive the code 42c but never opens the lock 18 which triggers the pointer 37 to move from the code 40c to code 40d. The pointer 37 therefore stays at pointing to code 40c while the pointer 44 has moved to point to code 42d. Next time a user wants to unlock the door, the server 20 will send code 42d which does not match code 40c of the series 36. Consequently, the user cannot open the lock. This problem may be solved by providing a set of codes, as indicated by a bracket 46 that are acceptable to unlock the lock 18. For example, the bracket 46 may include the codes 40b, 40c, 40d, 40e, 40f and 40g so that up to six users in a row may obtain the codes from the server 20 without using the device 16. Of course, the acceptable interval symbolized by the bracket 46 may include more codes or fewer codes. When the server 20 now sends the code 42d the user may enter the code 42d since the corresponding identical code 40d is within the set of the bracket 46.

After each time the device 16 is used, the bracket 46 may move forward one step in the series 36 similar to the stepping forward by the pointer 37. Also, the microprocessor 19 may move the pointer 37 to the code, such as code 40c, so that the pointer 37 is again automatically synchronized with the pointer 44 each time the device 16 is used. Preferably, the pointer 37 points to a code that is in the middle of the bracket 46 so that the position of the bracket 46 is adjusted accordingly.

It should be noted that there is no need to display any of the codes. Another important feature is that there is no electronic, radio, optical or any other type of remote wired/wireless or automatic communication between the communication device 14 and the lock 18. The user must enter the code 42 received from the server 20 manually into the lock 18 in order to unlock the lock.

Instead of using a number series it is possible to use the same random algorithm at the lock and the server so that the lock may generate a random code that is disclosed to the user. This random code is then sent to the server that in turn runs the same random algorithm to generate a second code. This second code is sent back to user's telephone. In the meantime, the lock has run the algorithm to generate the second code also. The user enters the second code into the lock that is matching the second code generated by the lock. As a result, the lock unlocks itself or provides the user access to the device.

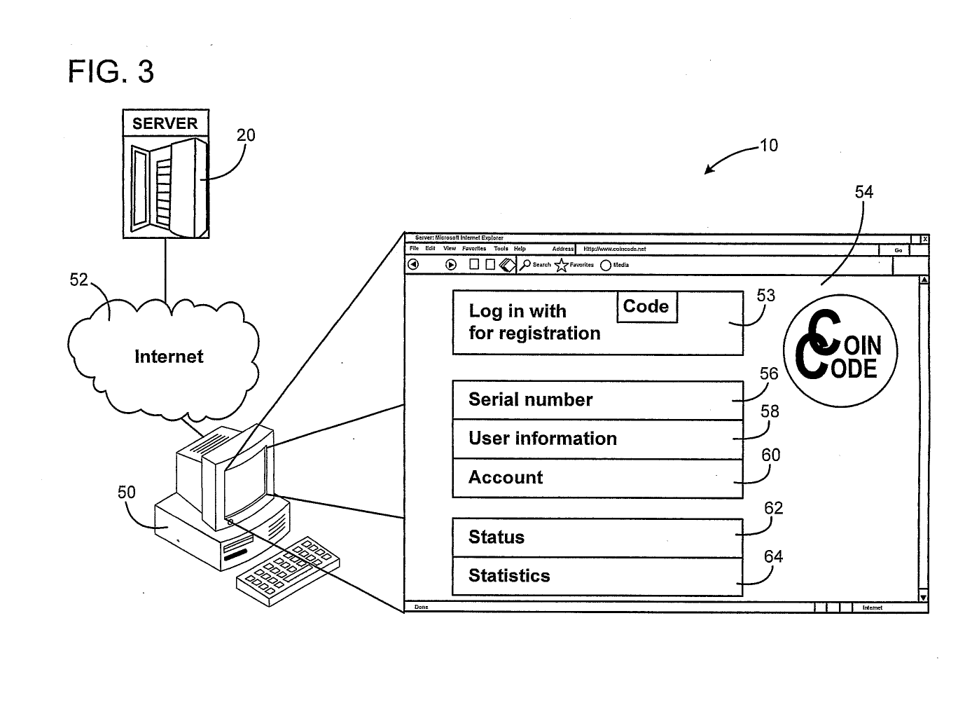

FIG. 3 is a schematic view of an alternative embodiment of the system 10. A user, such as a restaurant or other suitable users, may register with a computer 50 for the service by entering the Internet 52 to contact a website 54 of the service provider. The user may log in for registration 53 at a website 54. The user may enter a code or serial number 56 that is printed on the locks to gain access to serial numbers of the locks 18, user information 58 and accounts 60 to receive payments from the various locks. The user may also gain access to status information 62 and statistical information 64. The statistical information may show which product or toilet that is mostly or the least used. If, for example, a vending machine has run out of a product, the lock may be programmed to send a code back to the service provider that indicates that there is time to refill or recharge batteries. The service provider may offer the service of refilling or taking care of whatever needs to be done. This may be sent by email or any other suitable communication device. An important feature is that the registration process is self-administered and that no personal contact with the service provider is necessary.

While the present invention has been described in accordance with preferred compositions and embodiments, it is to be understood that certain substitutions and alterations may be made thereto without departing from the spirit and scope of the following claims.

1. A method of activating a device, comprising:
providing a communication device (14) in communication with a server unit (20) that has a processor for generating a number series (38) and an application device that has a processor (19) for generating a number series (36);
the user reading an identification number (30) and sending a message (32) including the identification number (30) to the server (20);
upon receipt of the identification code (30), the server (20) generating a code number (42c) pointed at by a pointer (44);
the server (20) sending the code number (42c) back to the communication device (14);
entering the code number (42c) into the application device (16);
the processor (19) comparing the code number (42c) with a number (40c) pointed at by a pointer (37) of the number series (36); and
the processor (19) sending an activation signal to an activation device (18) to activate the application device (18) when the code number (42c) is identical to the number (40c).

2. The method according to claim 1 wherein the method further comprises the user manually entering the number code into the activation device (16).

3. The method according to claim 1 wherein the method further comprises the server (20) moving the pointer (44) to a subsequent code number (42d).

4. The method according to claim 3 wherein the method further comprises the processor moving the pointer (37) to a subsequent number (40d) that matches the code number (42d).

5. The method according to claim 1 wherein the method further comprises the processor (19) identifying a number range (46) of acceptable numbers (40b, 40c, 40d, 40e, 40f, 40g) that triggers the processor to send the activation signal to the activation device even if the code number (42c) does not match a code number pointed at by the pointer (37) as long as the number pointed at is in the number range (46).

6. The method according to claim 1 wherein the method further comprises charging the user a fee (22) for the message (32).

7. The method according to claim 6 wherein the method further comprises charging sending a compensation payment (26) to a maintenance entity (28).

8. The method according to claim 1 wherein the method further comprises providing each application device with a unique identification number.

9. The method according to claim 1 wherein the method further comprises the activation signal sending an unlocking code number to unlock a lock on the application device.

10. The method according to claim 1 wherein the method further comprises using a random algorithm to generate code numbers.
